(19) United States
(12) Patent Application Publication
(10) Pub. No.: US 2006/0266692 A1
(43) Pub. Date: Nov. 30, 2006

(54) Microfabricated cross flow filter and method of manufacture

(75) Inventors: John S. Foster, Santa Barbara, CA (US); John C. Harley, Santa Barbara, CA (US); Steven H. Hovey, Goleta, CA (US); Richard T. Martin, Goleta, CA (US); Paul J. Rubel, Santa Barbara, CA (US); Hung D. Nguyen, Los Angeles, CA (US)

Correspondence Address: Dr. Jaquelin K. Spong, 2246 Mohegan Drive, Apt. A1, Falls Church, VA, 22043, US

(73) Assignee: Innovative Micro Technology, Goleta, CA (US)

(21) Appl. No.: 11/136,552

(22) Filed: May 25, 2005

(51) Int. Cl. B01D 63/00

(52) U.S. Cl. 210/321.84; 210/500.21; 210/500.22; 210/490; 216/2; 216/56

(57) ABSTRACT

A microfabricated cross flow filter may have multiple filtration stages. The filtration stages may include microfabricated filter barriers and gaps created in a substrate, thereby allowing very tight tolerances in the filter barrier and gap dimensions to be maintained. Using the microfabrication techniques, the filter barriers can be made having arbitrary shapes, and arranged at an angle or curved with respect to the flow direction, making the pressure drop across the filtration stage more uniform in the cross flow direction.

### BACKGROUND

This invention relates to cross flow filters for concentrating or purifying liquid samples. In particular, this invention relates to multistage cross flow filters which are formed using photolithographic fabrication techniques.

Cross-flow or tangential-flow filtration is commonly used in applications where concentration or purification of fluid samples is desired. Through the use of this technique, a volume of fluid may be processed while reducing the clogging issues that are commonly associated with depth-type (dead-end) filtration, wherein the fluid of interest is forced to flow primary perpendicular to the plane of the filter. Most commonly such cross flow filters may rely on the use of commercially available filtration membranes or filter papers, assembled in a non-disposable structure. The non-disposable assembly typically comprises at least two parallel plates which sandwich the filter membrane or paper between the plates, and form the flow channel for the fluid.

In such a cross flow filter, a fluid to be filtered travels over the surface of the filter in a direction largely parallel to the plane of the filter. The filter may be, for example, a porous cellulose filter for filtering particulate matter or semi-permeable membrane sheets for filtering materials of various chemical compositions. An exemplary cross flow filter 100 arrangement is shown in FIG. 1. A sample fluid is introduced through an inlet port 110 and traverses a cross flow filter structure 120 and then exits outlet ports 130 and 140, as shown by the arrows indicating the flow direction in FIG. 1. The cross flow filter 120 may block the transmission of particles 112 exceeding a certain size or having particular chemical characteristics, so that the effluent stream exiting at outlet port 140 has particles 112 of that size or type and larger, removed. The effluent stream exiting at outlet port 130 has all or most of the particles 112 which were too large, or were otherwise unable to pass through the cross flow filter structure 120. Therefore, the fluid stream exiting outlet port 130 has a concentrated proportion of particles 112, and the effluent stream exiting outlet port 140 has a diluted proportion of particles 112. In contrast, the fluid stream exiting outlet port 130 may have a diluted concentration of particles 114 which were able to pass through the cross flow filter structure 120, and the fluid stream exiting outlet port 140 may have an enhanced concentration of such particles 114.

Multistage cross flow filters can be constructed by laminating a series of filter papers or membranes with intervening spacer layers or support members, to form a cross flow filter with multiple filtration stages. As one or more of the filtration stages becomes clogged, the unit may be disassembled and the filter papers or membranes replaced. Such a filter assembly is described in, for example, U.S. Pat. No. 5,593,580 incorporated by reference herein in its entirety.

The advantage of cross flow filters over filters wherein the flow is entirely perpendicular to the plane of the filter, is that the filter is less likely to become clogged through use, and that the cross flow filter can produce effluent streams with a concentrated or diluted proportion of particles of a given size, as described above with respect to FIG. 1.

### SUMMARY

A number of disadvantages are associated with the cross flow filter structure 100 of FIG. 1. In particular, a pronounced non-uniform pressure distribution occurs across the filter or membrane 120, because of the high pressure inlet port 110 being located on the left side of the cross flow filter 100. Therefore, the fluid will preferentially flow primarily through the left hand portion of the filter or membrane, 120, and under-utilize the right hand portion. Accordingly, since the left hand portion will filter a larger proportion of the influent flow, it may become clogged or fouled, whereas the right hand portion is still serviceable.

Because the pores in the particulate filters used in prior art cross flow filters may be made by mechanically stamping or puncturing a flexible sheet, or using the voids between fibers of a paper sheet as the pores, the prior art cross flow filters do not have very tight control of the particle diameters of the particles transmitted or blocked by the filters or membranes of the prior art cross flow filters.

Furthermore, the cross flow filter 100 of FIG. 1 is not, in general, disposable. Therefore, when the filter or membrane 120 becomes clogged, the device must be disassembled and the filter or membrane sheet 120 replaced with a new filter or membrane sheet 120.

Systems and methods are described here for fabrication of a cross flow filter using microelectromechanical systems (MEMS) batch processing techniques. The resulting filter structure may have pores with tolerances which are very tightly controlled, resulting in improved filter selectivity.

The microfabricated cross flow filter may include at least one flow channel photolithographically defined in a substrate between an input orifice and an output orifice, wherein the flow channel is substantially in a plane parallel to a top surface of the substrate, and at least one filter structure disposed in the flow channel including a plurality of photolithographically defined barriers defining a filter line and separated by photolithographically defined gaps between the barriers, wherein at least a portion of the flow in the flow channel is in a direction tangential to the filter line.

The microfabricated cross flow filter may also have multiple filtration stages, all on a unitary substrate. The multistage cross flow may include a second filter structure also including a plurality of barriers photolithographically defined in the substrate and separated by photolithographically defined gaps between the barriers. In various exemplary embodiments, because the barriers and gaps in the filter structure are formed photolithographically, they may have various unusual shapes, such as crescents or trapezoids, in addition to the usual parallel-wall surfaces. Such unusual shapes may be used to accomplish various purposes, such as reducing the tendency of the microfabricated cross flow filter to clog, or to reduce the shear forces acting on the particles in suspension. In various other exemplary embodiments, the gaps in the second filter structure may be of a different size than the gaps in the first filter structure.

The multistage cross flow filter may produce multiple effluent streams each having particles in a particular range of sizes. Since the filtration stages are formed photolithographically, the multistage cross flow filter may be batch fabricated very inexpensively and may be disposable.

The filter structures may also be made at an angle with respect to the central axis of the flow, thereby distributing the flow evenly across all portions of the cross flow filter. The microfabricated cross flow filter may therefore combine aspects of dead-end filtering with aspects of cross flow filtering.

These and other features and advantages are described in, or are apparent from, the following detailed description.

### BRIEF DESCRIPTION OF THE DRAWINGS

Various exemplary details are described with reference to the following figures, wherein:

FIG. 1 is an illustration of a prior art cross flow filter;

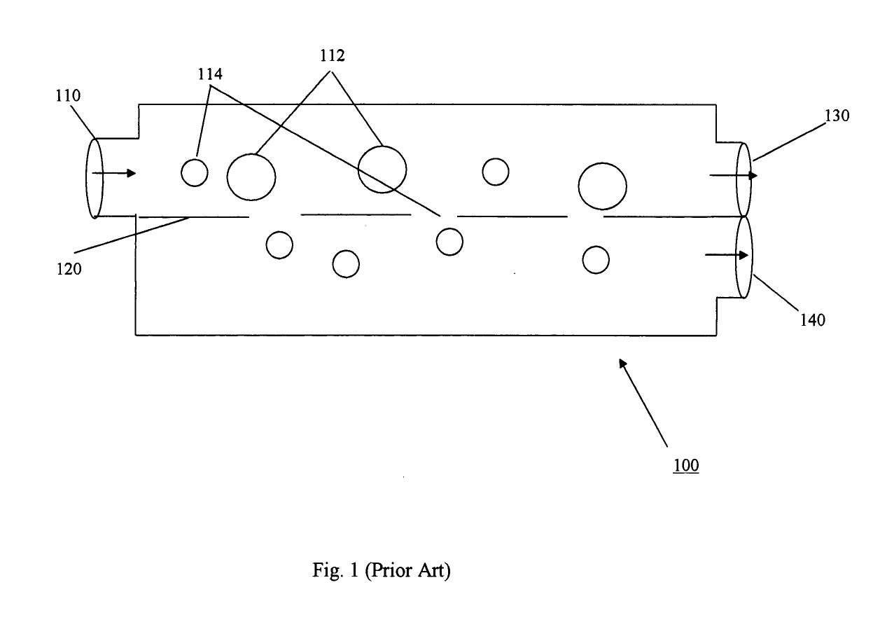

FIG. 2 is a perspective view of a first embodiment of a microfabricated cross flow filter with multiple filtration stages;

FIG. 3 illustrates an alternative embodiment of the barrier shape of the microfabricated cross flow filter of FIG. 2;

FIG. 4 illustrates another alternative embodiment of the barrier shape of the microfabricated cross flow filter of FIG. 2;

FIG. 5 is a side view of a second embodiment of a microfabricated multistage cross flow filter;

FIG. 6 is a perspective view of a third embodiment of a microfabricated cross flow filter with angled filter structures;

FIG. 7 is an exemplary embodiment of a cell sorting system using the microfabricated cross flow filter of FIGS. 2, 5 or 6;

FIG. 8 shows the results of a flow calculation for the microfabricated cross flow filter of FIG. 2; and

FIG. 9 is a micrograph of the microfabricated cross flow filter of FIG. 2 in operations

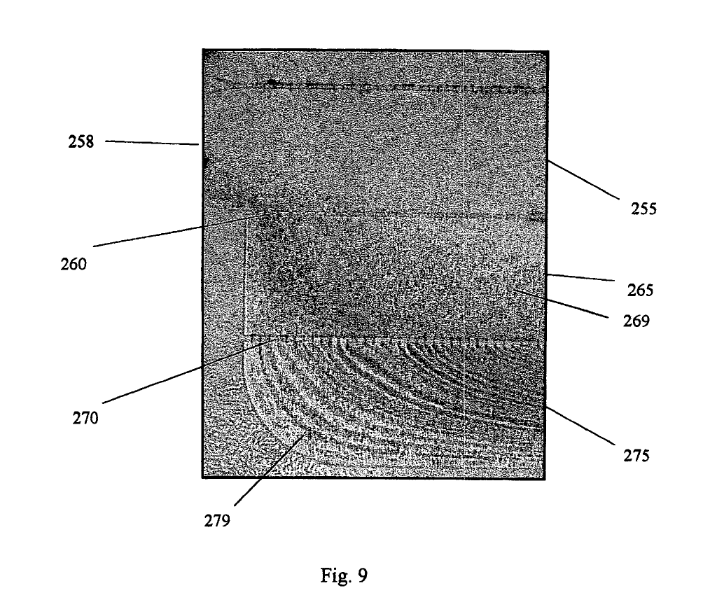

### DETAILED DESCRIPTION

In the systems and methods described herein, a cross flow filter is microfabricated on one or more substrates. In one exemplary embodiment, several filtration stages are created in the plane of the substrate, and the flow is substantially in the plane of the substrate, tangential to the filtration stages. In other exemplary embodiments, the filtration stages are created in separate substrates, which are then assembled into a filter structure.

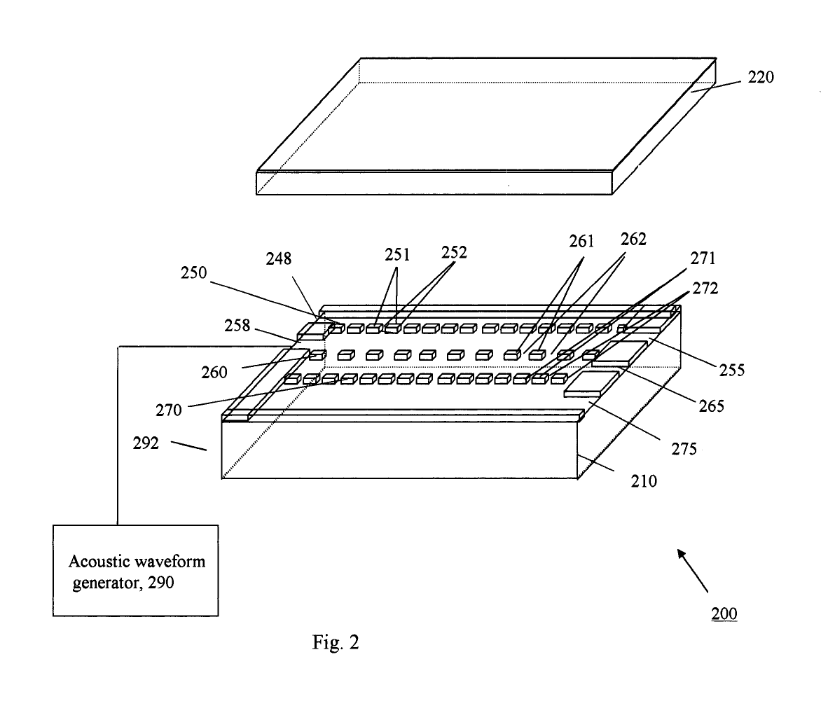

FIG. 2 is a perspective view of a first exemplary embodiment of a microfabricated cross flow filter 200 with multiple filtration stages 250, 260, and 270. A first flow channel may be defined between at least one inlet port 248 or 258, and at least one outlet port 255. The flow channel and filtration stages 250, 260, and 270 may all be photolithographically defined in a single substrate 210. Each filtration stage 250, 260, and 270 includes a plurality of barriers, for example, barriers 251 in filtration stage 250, barriers 261 in filtration stage 260, and barriers 271 in filtration stage 270. The barriers 251, 261 and 271 define filter lines in the filtration stage 250, 260 and 270, respectively. By virtue of the inlet ports 248 and 258, and outlet ports 255, 265 and 275, at least a portion of the flow in the flow channel is substantially tangential to the filter lines of filtration stages 250, 260 and 270. The barriers 251, 261 and 271 may be separated by gaps 252, 262 and 272, respectively, which form flow conduits through the filtration stages 250, 260 and 270, respectively. The gaps serve to block any particles larger than the gap dimension from traversing the filtration stage 250, 260 and 270, and to pass particles smaller than the gap dimension. The gaps in filtration stage 270 may be of a different size than the gaps in filtration stage 260, and therefore filtration stage 260 may pass different sized particles than filtration stage 270. For example, the gaps 262 of filtration stage 260 may be larger than gaps 272 of filtration stage 270, so that filtration stage 260 transmits larger sized particles than filtration stage 270.

Each filtration stage 250, 260 and 270 may be associated with an outlet port 255, 265 and 275, respectively. Each outlet port 255, 265, and 275 serves to output an effluent stream containing only particles smaller that the respective gaps 252, 262, and 272 of filtration stages 250, 260 and 270. Therefore, importantly, outlet port 255, for example, may produce a fluid stream which contains particles which cannot traverse the first filtration stage 260. The presence and functioning of this outlet port 255 may be important to reduce the clogging tendencies of filtration stage 260, as it may remove particles of a size which cannot traverse filtration stage 260, and would otherwise remain trapped in this chamber, eventually leading to the clogging of filtration stage 260.

Outlet port 265 produces an effluent stream with a preponderance of particles within a particular size range, in this case, in the size range smaller than the gaps 262 in filtration stage 260 and larger than gaps 272 in filtration stage 270. Similarly, outlet port 275 produces a fluid stream with a preponderance of particles smaller than the gaps 272 in filtration stage 270.

The cross flow filter 200 may have two or more input ports 248 and 258 to introduce an influent stream to the microfabricated cross flow filter 200. Input port 248 may introduce a solvent or dilutant, such as saline, and input port 258 may introduce a fluid stream containing the particulate matter in suspension, such as human blood. Furthermore, any of outlet ports 255, 265 or 275 may be coupled to input ports 248 or 258 to provide further filtering of the effluent streams produced at outlet ports 255, 265 or 275.

In one exemplary embodiment of cross flow filter 200, the gaps 252 and 272 are both about 3 μm in size, and gaps 262 are between about 10 μm and about 15 μm, and may be nominally about 13 μm in size. The width of the barriers 251, 261 and 271 may be, for example, about 20 μm in size. Accordingly, in this embodiment, outlet port 265 produces an effluent stream with a preponderance of particles smaller than 13 μm, and outlet port 275 produces an effluent stream with particles smaller than 1 μm.

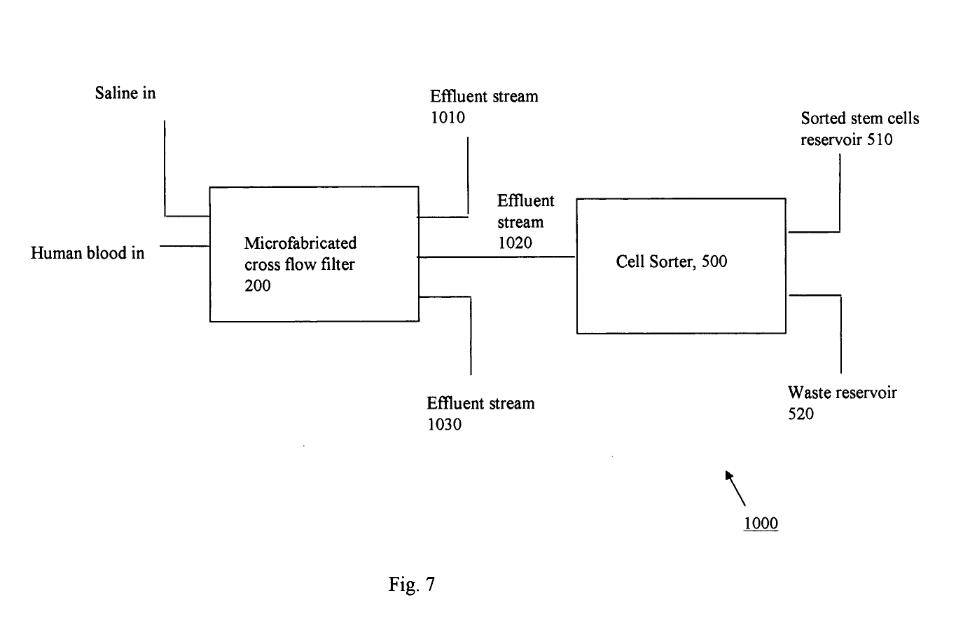

As mentioned above, this embodiment may be particularly suited for the filtration of biological samples, such as human blood. In this application, saline may be injected into port 248, and a blood sample into port 258. The saline may serve to thin the blood and reduce clogging in microfabricated cross flow filter 200. The first filtration stage 250 may serve to remove any large particles or debris from the saline stream. Suspended in the blood sample injected into port 258 may be a large concentration of erythrocytes, such as red blood cells, which are a biconcave disk about 7 μm in diameter and 3 μm thick, leukocytes such as white blood cells which may be 12-15 μm in diameter, and platelets which may be 1-3 μm in diameter. Also suspended in the blood plasma may be a smaller concentration of hematopoietic stem cells (progenitor cells, capable of generating all types of blood cells) which may be 4-8 μm in diameter. Using microfabricated cross flow filter 200, the effluent stream produced by outlet port 265 may have an enhanced concentration of red blood cells and blood stem cells relative to the effluent streams produced by outlet port 275. Such an effluent stream with an enhanced concentration of blood stem cells may be useful for performing additional downstream manipulations or tests, such as cell lysis, binding with a fluorescent marker, or sorting the blood cells as will be discussed further below with respect to FIG. 7. Effluent stream 275, in contrast, may contain few or no larger particles, but instead may contain only a stream of purified platelet particles, as only the platelets may fit through the last filtration stage 270.

When using cross flow filter 200 to filter samples which clog easily, for example, biological samples such as human blood, it may be advantageous to couple cross flow filter 200 to an acoustic modulator 290. Acoustic modulator 290 generates acoustic waves or pressure pulses, which can be coupled to the sample fluid in the cross flow filter 200 using any convenient means, such as a probe tip or wire 292, which may transmit acoustic energy from acoustic modulator 290 to cross flow filter 200. In particular, the acoustic modulation may be applied to the sample fluid as a pressure pulse by contacting the acoustic modulator 290, such as a speaker diaphragm, to the input port 258 of the microfabricated cross flow filter 200, as shown in FIG. 2. The acoustic energy may loosen clogs or coagulated materials, and encourage their exit from outlet ports 255, 265 and 275. The use of acoustic modulator 290 may therefore prolong the duration of use of cross flow filter 200, before cleaning or discarding. A particularly effective frequency range of acoustic modulation may be in the range of, for example, 20 to 200 Hz. The acoustic signal may be applied at intervals of, for example, 1 to 3 Hz.

Each of filtration stages 250, 260 and 270 may be created photolithographically, by patterning the appropriate features in a substrate 210. The substrate 210 may be composed of any suitable material, for example, silicon or glass, which is compatible with the photolithographic processes used to form the features in the substrate. One particularly convenient substrate may be a silicon-on-insulator (SOI) substrate, which is a thick silicon wafer (the “handle” wafer), for example 675 μm thick, on which a thin insulating layer such as silicon dioxide (SiO₂), 1 μm thick for example, is grown or deposited. A thinner upper layer of silicon (the “device” layer), from about 1 to over about 100 μm thick for example, is then deposited, bonded or otherwise secured to the top of the silicon dioxide layer. The filter barrier features 251, 261 and 271, may then be formed photolithographically in the thinner silicon device layer, down to the oxide by, for example, deep reactive ion etching (DRIE). The oxide layer may then form the etch stop for the DRIE process. Based on the above-mentioned thicknesses of the layers of the silicon-on-insulator substrate, the depth of the flow channels in microfabricated cross flow filter 200 may be anywhere from 1 to over 100 μm deep, as determined by the thickness of the silicon device layer, which was removed in the DRIE process to form the channels.

It should be understood that the exemplary upper bound of 100 μm for the device layer is exemplary only, and that any thickness of device layer may be chosen to achieve certain purposes. For example, the device layer may be chosen to be hundreds of microns thick, in order to increase the active filter area. However, the increased active filter area may be achieved at the price of reduced control of filter gap spacing, as the DRIE etch may not result in perfectly perpendicularly etched walls, as the aspect ratio of the etch may be inherently limited.

The photolithographic process used to form the features in the device layer may include depositing a layer of photoresistive material over the silicon-on-insulator substrate 210. The photoresistive material may then be illuminated through a mask which contains the pattern desired in the microfabricated cross flow filter, for example, the flow channels and the filtration stages 250, 260 and 270. For a positive photoresist, the illuminated portions of the photoresistive material may then be developed and removed. Alternatively, a negative photoresist may also be used, in which case the unexposed portions may be dissolved and removed. The etching process, for example, deep reactive ion etching (DRIE), may then be performed on the exposed areas of the substrate to form the flow channel and the gaps 252, 262 and 272 between the barriers 251, 261, and 271 of filtration stages 250, 260 and 270, respectively. Because the gaps between the barriers are created photolithographically, the tolerances of the gaps 252, 262 and 272 may be controlled very tightly, for example to within ±0.1 μm.

Using, for example, an SOI wafer as the substrate 210, and after patterning substrate 210 to form the flow channels and filtration stages, substrate 210 may be covered with a top cover 220, for example, a glass slide or another silicon wafer, to enclose the flow channel between inlet ports 248 and 258, and outlet ports 255, 265 and 275 through filtration stages 250, 260 and 270. The top cover 220 may be secured to substrate 210 by, for example, using epoxy or a photolithographically patterned bonding material.

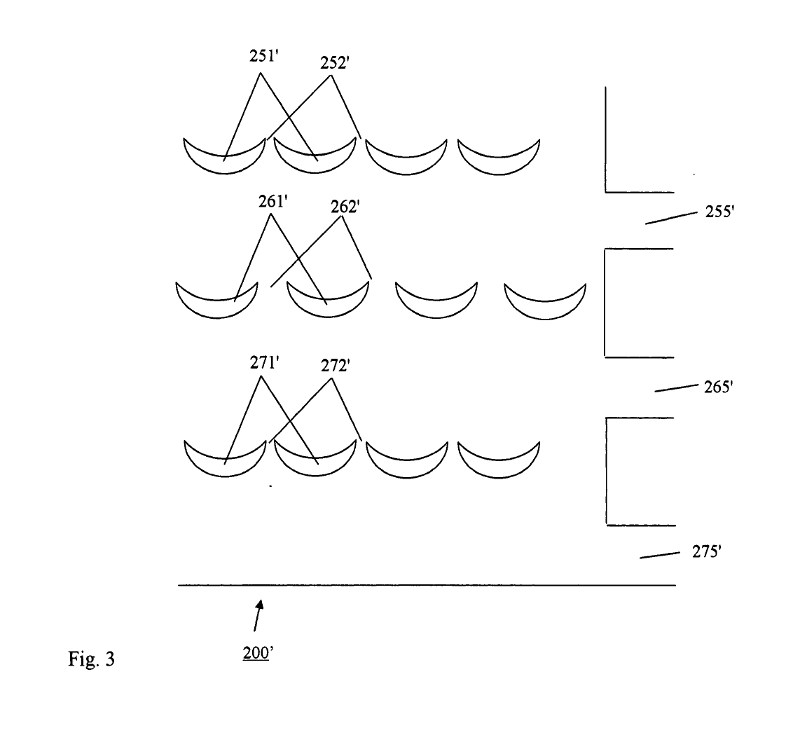

Since the barriers 251, 261 and 271 are formed photolithographically by etching patterns exposed in a photoresist, any of a number of alternative shapes for barriers 251, 261 and 271 may be employed to achieve various purposes. FIG. 3 illustrates an alternative embodiment 200′ of microfabricated cross flow filter 200. In microfabricated cross flow filter 200′, the barriers are formed in crescent shapes 251′, 261′ or 271′. This may help avoid having particles become lodged in gaps 252′, 262′ and 272′, as the particles may prefer to rest in the nook of the crescent barriers 251′, 261′ or 271′ or to exit the microfabricated cross flow filter through outlet ports 255′, 265′ or 275′.

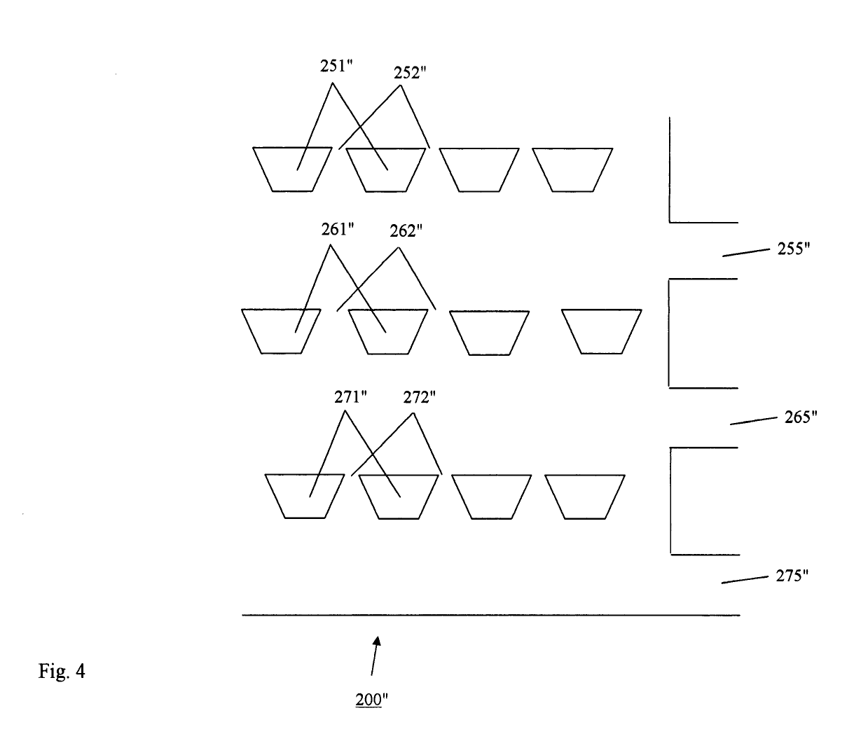

FIG. 4 shows another alternative embodiment 200″ of microfabricated cross flow filter 200. In microfabricated cross flow filter 200″, the barriers 251″, 261″ and 271″ are formed in trapezoidal shapes. The trapezoidal-shapes maintain the minimum gap spacing 252″, 262″ and 272″ only for a very brief distance, before expanding the channels 252″, 262″ and 272″ as shown in FIG. 4. These trapezoidal shapes 251″, 261″ or 271 ″ may be advantageous in that the duration during which the particles are forced to flow through the narrow gaps 252″, 262″ and 272″ may be reduced or minimized, after which the particles exit through outlet ports 255″, 265″ or 275″. This feature may reduce or minimize the amount of time that the particles experience large shear forces, as they pass through the gaps 252″, 262″, and 272″. Since the ability of, in particular, biological particles to withstand shear forces may be limited, this embodiment may be particularly suited to the filtration of biological samples.

Although two particular examples of barrier shapes are shown in FIGS. 3 and 4, it should be understood that these barrier shapes are exemplary only, and that invention is not limited to these particular shapes. In fact, any shape that can be formed using microfabrication techniques such as those outlined above may be used to create the microfabricated cross flow filter 200.

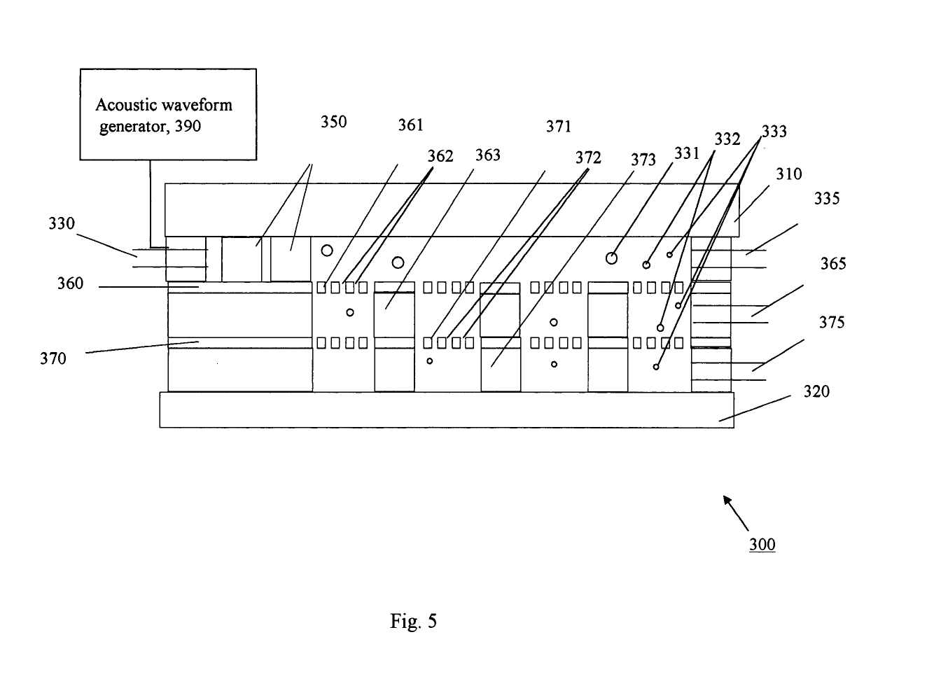

FIG. 5 shows a side view of a second exemplary embodiment of a microfabricated cross flow filter 300. Microfabricated cross flow filter 300 may include two or more filtration stages 360 and 370, each of which is fabricated in a single, separate substrate layer.

A sample fluid may be input to microfabricated cross flow filter 300 via an input port 330. Clearance for input port 330 may be afforded by spacer layer 350, interposed between a top plate 310 and a first filtration stage 360. The spacer layer 350 also provides a flow channel between upper plate 310 and first filtration stage 360. The top plate 310 may be made of any suitable material, and may be transparent, for example. The sample fluid may contain at least three different sizes of particles, a relatively large sized particle 331, a medium sized particle 332, and a relatively small sized particle 333.

The individual substrate layers are microfabricated using photolithographic techniques similar to those described above with respect to FIG. 2, to form a plurality of barriers 361 in layer 360, for example, each of which may be separated by a gap 362. The gaps 362 in filtration stage 360 may allow only particles smaller than the gap size, such as particles 332 and 333, to cross the filtration stage 360, whereas particles 331 may not cross filtration stage 360.

Filtration stage 370 may be similarly formed, including a plurality of barriers 371 separated by gaps 372. The gaps 372 in layer 370 may be narrower than gaps 362 in layer 360. Therefore, filtration stage 370 may only allow particles of a certain size, for example particles 333 to traverse the filter barrier, whereas particles 332 and 331 may not cross filtration stage 370. Therefore, the particles contained in the region below filtration stage 370 may only be the relatively small sized particles 333, whereas the particles contained in the region below filtration stage 360 may be particle sizes 332 and 333.

In order to provide outlet ports and flow channels for each effluent stream, the filtration stages 360 and 370 are separated by spacer layers 363 and 373, respectively. Spacer layer 373 may separate filtration stage 370 from the bottom substrate 320. Outlet ports 335, 365 and 375 may guide the effluent streams from the microfabricated cross flow filter 300. The effluent stream emerging from outlet port 335 may contain excess sample fluid and a reduced concentration of particles 331, 332 and 333. The effluent stream emerging from outlet port 365 may contain particles 332 as well as particles 333. The effluent stream emerging from outlet port 375 may only contain particles 333. Depending on the effluent flow rates from outlet ports 335, 365 and 375, the flow through microfabricated cross flow filter 300 may still be substantially parallel to the top plate 310, and at least a portion of the flow may be tangential to filtration stages 360 and 370.

Although not shown in FIG. 5, any of outlet ports 335, 365 and 375 may be routed back to inlet port 330, to provide further filtering of the effluent stream emerging from outlet ports 335, 365 or 375.

Microfabricated cross flow filter 300 may be made by first fabricating filtration stages 360 and 370, and then assembling them with spacer layers 363 and 373 using any convenient adhesive, such as epoxy, which is inert to the components of the fluid stream The upper plate 310 may then also be epoxied to the upper spacer layer 350 which is first epoxied to the first filtration stage 360. Spacer layer 350 provides clearance for the installation of inlet port 330 and outlet port 335.

Like microfabricated cross flow filter 200, microfabricated cross flow filter 300 may be coupled to an acoustic modulator 390, which may help microfabricated cross flow filter 300 avoid becoming clogged by particles 331, 332 and 333.

Microfabricated cross flow filter 300 of FIG. 5 may have the advantage that the filter area is increased compared to the embodiment depicted in FIG. 2. However, the embodiment depicted in FIG. 5 may have the disadvantage that it is somewhat more difficult to fabricate and assemble.

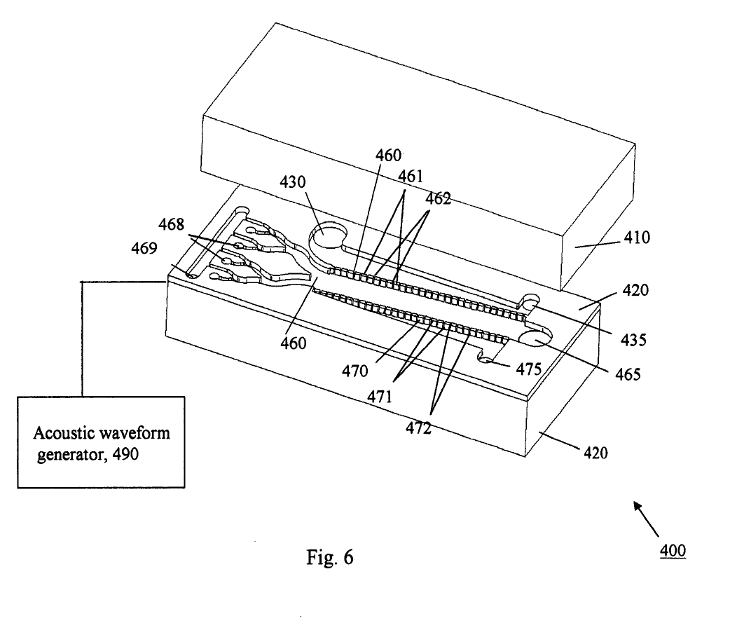

A third embodiment of microfabricated cross flow filter 400 is shown in FIG. 6. Microfabricated cross flow filter 400 is similar to the first embodiment shown in FIG. 2, however, the filtration stage 460 may be formed at an angle with respect to the wall between an inlet port 430 and outlet port 435. Similarly, the second filtration stage 470 may be formed at an angle with respect to filtration stage 460. (Although filtration stage 470 is shown as being parallel to filtration stage 460, it should be understood that such is not necessarily the case, and that filtration stage 470 ray form any other angle with respect to filtration stage 460, as discussed further below.)

Microfabricated cross flow filter 400 may also be provided with one or more additional input ports for introducing the sample fluid. For example, human blood may be introduced at inlet port 468, and various additional reagents such as binding agents which bind to certain blood constituents, may be introduced into the blood sample at multiple input ports 469. By providing a plurality of such input ports 469, the reagent may become more thoroughly mixed with the fluid sample before entering the filter structures 460 and 470.

The filter structures 460 and 470 may be angled with respect to the inlet port and outlet port to obtain improved filter efficiency. To improve filter efficiency, the flow rate through the filter may be more uniform from inlet to outlet. As fluid travels from the inlet 430 to the outlet 435, a portion of the fluid may pass through the filter stage, 460, meaning that as the fluid approaches 435, there is less of it. By designing filtration stage 460 at an angle, it is possible to obtain more nearly uniform pressure drop and hence flow through the filter at all points. Because fluid is both entering and leaving the central region of the filter between 460 and 470, 460 and 470 will be more nearly parallel. However, depending on the desired ratio of flow through 460 and 470, and the amount of fluid exiting through outlet port 465, the angle may not be parallel for the same reasons as mentioned above. Finally, in the region between 470 and 475, the angle of the filtration stage 470 with respect to the solid wall is again calculated to provide a nearly uniform back-pressure across the entire length of the filter structure.

The filter stages 460 and 470 may be fabricated using designs and techniques similar to those employed for filter stages 360 and 370 of microfabricated cross flow filter 300, and filter stages 250, 260 and 270 of microfabricated cross flow filter 200. In particular, filtration stages 460 and 470 may be formed in the same substrate 420, which may, for example, be silicon, silicon-on-insulator, or any other suitable material, compatible with the processes used to form the features of filter stages 460 and 470. To seal microfabricated cross flow filter 400, a plate or glass slide 410, for example, may be secured, for example using epoxy or a photolithographically patterned bonding material, to the top surface of the substrate 420. Any gap remaining between the plate or slide 410 and the substrate 410 should preferably be smaller than the gaps 462 and 472 between barriers 461 and 471 in each of filtration stages 460 and 470, respectively, in order to avoid having particles of diameter larger than the gaps 462 and 472 leak around filtration stages 460 and 470.

Although microfabricated cross flow filter 400 is depicted with the barriers 461 and 471 of filtration stages 460 and 470, respectively, arranged to form straight lines, it should be understood that this embodiment is exemplary only, and that barriers 461 and 471 may be arranged to form any of a number of shapes, such as curves, or portions of straight lines and portions of curves. Any shape which can be formed lithographically on a substrate surface can be used for the arrangement of barriers 461 and 471. For example, a complex shape such as a portion of an ellipse or parabola may be used for the arrangement of barriers 461 and 471, in order to make the back pressure across barriers 461 and 471 follow any prescribed function across the filtration stage 460 and 470, respectively.

As was noted above with respect to microfabricated cross flow filters 200 and 300, any of the effluent streams emerging from the outlet ports 435, 465 or 475 may be routed back to the inlet ports 430, 468 or 469, to perform additional filtering of the fluid stream.

Like microfabricated cross flow filters 200 and 300, microfabricated cross flow filter 400 may be coupled to an acoustic modulator 490, which may help microfabricated cross flow filter 400 avoid becoming clogged by particles.

It should be understood that any of microfabricated cross flow filters 200, 300 or 400 may be coupled to one or more additional microfabricated cross flow filters 200, 300 or 400, in a series-type or parallel-type arrangement. In such a series arrangement, the effluent stream from one microfabricated cross flow filter becomes the influent stream for a next microfabricated cross flow filter. Using a series arrangement of multiple microfabricated cross flow filters, effluent streams having enhanced purity or concentrations of a species of interest in the fluid sample may be obtained. A parallel arrangement may be used to increase the overall throughput of the microfabricated cross flow filter system Furthermore, any one of microfabricated cross flow filters 200, 300 or 400 may be combined with any other type of microfabricated cross flow filter 200, 300 or 400 in a series or parallel arrangement.

Any of microfabricated cross flow filters 200, 300 or 400 may also be used as an input stage for on a device which further manipulates the filtered sample. For example, microfabricated cross flow filter 200, 300 or 400 may be used as an input stage to a cell sorting chip, such as that described in U.S. Pat. No. 6,838,056, incorporated herein by reference in its entirety. An exemplary embodiment of such a system is shown in FIG. 7. FIG. 7 shows a cell sorting system 1000, including microfabricated cross flow filter 200 and cell sorting chip 500. Although microfabricated cross flow filter 200 is shown in FIG. 7, it should be understood that microfabricated cross flow filter 200 may alternatively be microfabricated cross flow filter 300 or 400, as well. Microfabricated cross flow filter 200 may produce three effluent streams, 1010, 1020 and 1030. Effluent stream 1010 contains all particles that were unable to traverse the first filtration stage 260. Effluent stream 1020 contains all particles which were able to traverse filtration stage 260 but unable to traverse filtration stage 270. Finally, effluent stream 1030 contains all particles that were able to traverse filtration stage 270. Accordingly, since human hematopoietic stem cells are about 4-8 μm in diameter, whereas platelets are about 2 μm or less in diameter, effluent stream 1020 may contain an enriched population of human hematopoietic stem cells, and a relatively depleted population of platelets.

In the cell sorting system of FIG. 7, microfabricated cross flow filter 200 has effluent stream 1020 coupled to cell sorting chip 500, and effluent streams 1010 and 1030 may be discarded. Cell sorting chip 500 may then be used to sort the human hematopoietic stem cells based on, for example, the detection of fluorescence from a fluorescent marker affixed to or expressed within the human hematopoietic stem cells. On the basis of this fluorescence, cell sorting chip 500 may be able to distinguish between cancerous stem cells and non-cancerous stem cells, for example. Non-cancerous stem cells may be separated and collected in an output reservoir 510, whereas cancerous stem cells are routed to a waste reservoir 520. The non-cancerous hematopoietic stem cells may then be returned to the patient's body, where they may help replenish the patient's supply of other constituent cells of the blood.

Use of microfabricated cross flow filter 200, 300 or 400 may thereby concentrate human hematopoietic stem cells for sorting by the cell sorting chip, and also exclude other particles found in human blood from entering the chip and potentially clogging the chip or otherwise interfering with its operation. In particular, microfabricated cross flow filter 200 may improve the functioning of the cell sorting chip 500, by increasing the concentration of the species of interest, the human hematopoietic stem cells.

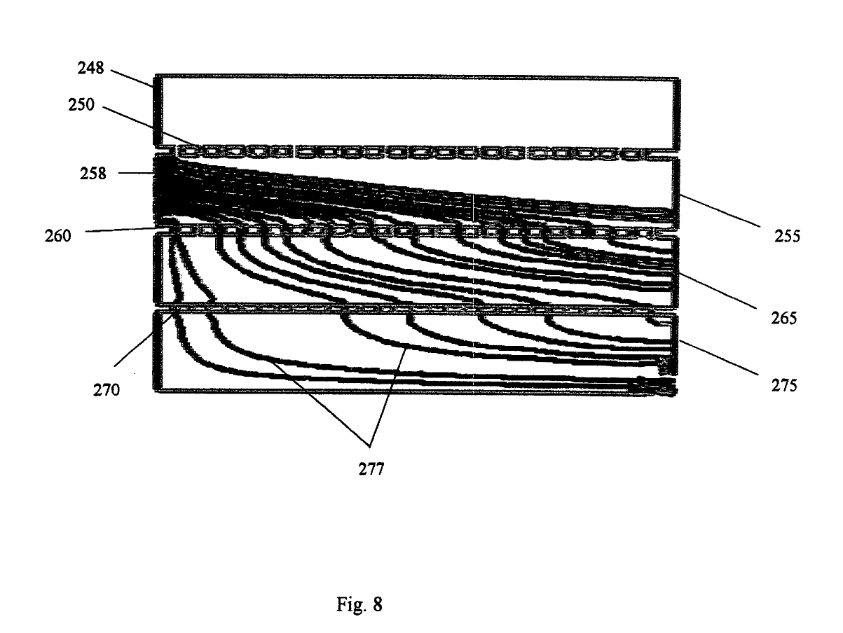

FIG. 8 shows the results of a fluid model of microfabricated cross flow filter 200. Each of the depicted lines in FIG. 8 illustrates a stream line in the fluid model. The model shows the flow through the microfabricated cross flow filter 200, as a result of inputting a sample stream into input port 258, and a solvent or dilutant into input port 248. The stream lines show the trajectory of various portions of the flow through filtration stages 260 and 270. As shown in FIG. 7, as a function of the pressure applied to the solvent stream through input port 248, a large fraction of the flow traverses filtration stage 260 rather than exiting through outlet port 255. At filtration stage 270, again a large fraction of the flow traverses filtration stage 270, although a significant portion of the flow also exits at outlet port 265. Reference numbers 277 identify stream lines which traversed filtration stage 270. Since no other outlet ports are available, all of the remainder of the flow which traversed filtration stage 270 exits at outlet port 275.

FIG. 8 is a microscopic image of an actual microfabricated cross flow filter, such as that modeled in FIG. 7, which is filtering a sample of human blood input at input port 258, along with saline input at input port 248. FIG. 8 qualitatively confirms the flow modeled in FIG. 7, wherein most of the particles, including human hematopoietic stem cells 269 in the blood traverse filtration stage 260, and many of the smaller blood cells 279 also traverse filtration stage 270. Therefore, the effluent stream emerging from outlet port 265 contains a concentrated proportion of human hematopoietic stem cells 269 relative to blood cells 279.

While various details have been described in conjunction with the exemplary implementations outlined above, various alternatives, modifications, variations, improvements, and/or substantial equivalents, whether known or that are or may be presently unforeseen, may become apparent upon reviewing the foregoing disclosure. For example, while only two or three filtration stages are shown in the embodiments depicted in FIGS. 3-6, it should be understood that the techniques and designs disclosed here may be extended to any number of filtration stages. Furthermore, details relating to the layout of the filter stages, and the shapes and dimensions of the features, are intended to be illustrative only, and the invention is not limited to such embodiments. Accordingly, the exemplary implementations set forth above, are intended to be illustrative, not limiting.

What is claimed is:

1. A cross flow filter for filtering a sample fluid, comprising:
at least one flow channel microfabricated in at least one substrate between an input orifice and an output orifice, wherein the flow in the flow channel is substantially in a plane parallel to a top surface of the at least one substrate; and
at least one filter structure disposed in the flow channel, including a plurality of microfabricated barriers defining a filter line and separated by microfabricated gaps between the barriers, wherein at least a portion of the flow in the flow channel is in a direction substantially tangential to the filter line.

2. The cross flow filter of claim 1, further comprising:
a second filter structure disposed in the flow channel, including a plurality of barriers microfabricated in the at least one substrate and separated by microfabricated gaps between the barriers.

3. The cross flow filter of claim 1, wherein the barriers are at least one of rectangular-shaped, crescent-shaped and trapezoidal-shaped.

4. The cross flow filter of claim 1, wherein the barriers are arranged in a straight line disposed at an angle with respect to a direction of flow between the input orifice and the output orifice.

5. The cross flow filter of claim 1, wherein the barriers are arranged in a curve between the input orifice and the output orifice.

6. The cross flow filter of claim 1, wherein the at least one substrate comprises a silicon-on-insulator substrate.

7. The cross flow filter of claim 1, further comprising a second filter structure including a plurality of barriers microfabricated in a second substrate and separated by microfabricated gaps.

8. The cross flow filter of claim 2, further comprising a second output orifice disposed between the at least one filter structure and the second filter structure.

9. The cross flow filter of claim 1, further comprising an upper plate secured to the at least one substrate that confines the flow channel between the input orifice and the output orifice.

10. The cross flow filter of claim 2, wherein the gaps between the barriers of the second filter structure are of a different size than the gaps between the barriers of the at least one filter structure.

11. The cross flow filter of claim 1, further comprising an acoustic modulator which delivers acoustic energy to at least one of the sample fluid and the substrate.

12. A system for sorting cells in a biological sample, comprising:
the cross flow filter of claim 1 for filtering the biological sample; and
a microfabricated cell sorting chip coupled to the cross flow filter, which sorts cells in the filtered sample, based on laser-induced fluorescence from a marker affixed to the cells of interest.

13. A method for fabricating a cross flow filter for filtering a sample fluid, comprising:
microfabricating at least one flow channel in a substrate between an input orifice and an output orifice, wherein flow in the flow channel is substantially in a plane parallel to a top surface of the substrate; and
microfabricating at least one filter structure disposed in the flow channel, including a plurality of barriers defining a filter line separated by gaps between the barriers, wherein at least a portion of the flow in the flow channel is in a direction substantially tangential to the filter line.

14. The method of claim 13, further comprising:
microfabricating a second filter structure including a plurality of barriers defined in the substrate and separated by microfabricated gaps between the barriers, wherein the gaps in the second filter structure are of a different size than the gaps in the at least one filter structure.

15. The method of claim 13, wherein the steps of microfabricating the at least one flow channel and microfabricating the at least one filter structure each comprises:
illuminating a photoresistive material through a mask;
removing a portion of the photoresistive material based on the illumination pattern;
etching a filter feature in the areas not covered by photoresistive material.

16. The method of claim 13, wherein the substrate is a silicon-on-insulator substrate.

17. The method of claim 13, further comprising:
securing a top plate to the substrate to enclose the flow channel.

18. The method of claim 14, further comprising:
forming a second output orifice between the first filter structure and the second filter structure.

19. A method for filtering a fluid sample comprising:
inputting a first fluid under pressure to a first input port of a microfabricated cross flow filter formed on a substrate;
inputting a second fluid under pressure to a second input port of the microfabricated cross flow filter; and
applying acoustic energy to at least one of the sample fluid and the microfabricated cross flow filter.

20. The method of claim 19, wherein the first fluid is a dilutant and the second fluid is human blood.
